(19) United States
(12) Patent Application Publication
(10) Pub. No.: US 2016/0125525 A1
(43) Pub. Date: May 5, 2016

(54) REQUEST TRACKER TOOL

(71) Applicant: BANK OF AMERICA CORPORATION, CHARLOTTE, NC (US)

(72) Inventors: Carrie Anne Hanson, Charlotte, NC (US); Alicia C. Jones-McFadden, Fort Mill, SC (US); Craig Sobol, Waxhaw, NC (US); Brent Alan Shelkey, Huntersville, NC (US); Kimberly Ya-chin Chang, Houston, TX (US); Sarah Beth Gottfried, Westlake, OH (US); Wang Liang, Pasadena, CA (US); Neha Rani Rathi, Reston, VA (US); Anthony Scott Wong, Union, KY (US)

(21) Appl. No.: 14/530,333

(22) Filed: Oct. 31, 2014

(51) Int. Cl. G06Q 40/02; G06F 21/62

(52) U.S. Cl. CPC G06Q 40/02; G06F 21/6245

(57) ABSTRACT

Embodiments of the invention are directed to systems, methods and computer program products for providing an online banking customer interface with comprehensive access to all of the customer's accounts, an activity list and any outstanding customer requests. Embodiments determine that the customer has been authenticated to a financial institution online banking session; in response to determining the customer has been authenticated, initiate presentation of a customer interface comprising a listing of all of the customer's accounts, an activity list, and a listing of all of the customer's requests; determine a status of at least one customer request; and present the status of the at least one customer request. Some embodiments present a resolution process associated with at least one customer request that includes a plurality of steps to be completed, a plurality of expected completion dates each associated with the steps, and a current step.

### BACKGROUND

In some circumstances, a customer may desire to know the status of a request. Typically, the customer must determine an appropriate phone number to call, wait for a knowledgeable representative to join the call and inquire regarding status of a request. Even then, in some cases, the customer does not receive up-to-date information regarding the status of a request.

### BRIEF SUMMARY

Embodiments of the invention are directed to systems, methods and computer program products for providing an online banking customer interface with comprehensive access to all of the customer's accounts, an activity list and any outstanding customer requests. The apparatus includes a memory; a processor; and a computing module stored in the memory, executable by the processor, and to cause the processor to determine that the customer has been authenticated to a financial institution online banking session; in response to determining the customer has been authenticated, initiate presentation of a customer interface comprising a listing of all of the customer's accounts, an activity list, and a listing of all of the customer's requests. The computing module also causes the processor to determine a status of at least one customer request; and present, as part of the customer interface, the status of the at least one customer request.

In some embodiments, determining the status of the at least one customer request comprises accessing a request status table comprising a plurality of request status entries, the table automatically updated when any request status changes. In some such embodiments, the computing module further causes the processor to periodically or continuously access one or more request systems to determine whether any request status has changed; and if so, update the request status entry corresponding to the changed request status.

In some embodiments, the computing module further causes the processor to receive, from a plurality of sources, request status updates; and in response to receiving request status updates, updating any request status entries corresponding to the received request status updates.

In some embodiments, the computing module further causes the processor to initiate presentation of a resolution process associated with at least one customer request, the resolution process comprising a plurality of steps to be completed, a plurality of expected completion dates each associated with one of the plurality of steps, and a current step of the process. In some such embodiments, the computing module further causes the processor to update the resolution process when the steps, completion dates or current step changes. In other such embodiments, the computing module further causes the processor to determine that at least one of the steps, completion dates or current step has changed; and initiate communication of a notification to the customer, the notification indicating that the at least one step, completion date or current step has changed.

In some embodiments, the computing module further causes the processor to determine that an activity associated with one of the customer's accounts or requests will occur within a predetermined period of time; and initiate communication of a notification to the customer, the notification indicating that the activity will occur within the predetermined period of time.

In some embodiments, the computing module further causes the processor to determine that a pending request requires customer attention; initiate communication of a notification to the customer, the notification indicating that the pending request requires customer attention; and receive customer input regarding the pending request.

According to embodiments of the invention, a method includes determining that the customer has been authenticated to a financial institution online banking session; in response to determining the customer has been authenticated, initiating presentation of a customer interface comprising a listing of all of the customer's accounts, an activity list, and a listing of all of the customer's requests. The method also includes determining a status of at least one customer request; and presenting, as part of the customer interface, the status of the at least one customer request.

In some embodiments, determining the status of the at least one customer request comprises accessing a request status table comprising a plurality of request status entries, the table automatically updated when any request status changes. In some such embodiments, the method also includes periodically or continuously accessing one or more request systems to determine whether any request status has changed; and if so, update the request status entry corresponding to the changed request status.

In some embodiments, the method includes receiving, from a plurality of sources, request status updates; and in response to receiving request status updates, updating any request status entries corresponding to the received request status updates.

In some embodiments, the method includes initiating presentation of a resolution process associated with at least one customer request, the resolution process comprising a plurality of steps to be completed, a plurality of expected completion dates each associated with one of the plurality of steps, and a current step of the process. In some such embodiments, the method also includes updating the resolution process when the steps, completion dates or current step changes. In other such embodiments, the method also includes determining that at least one of the steps, completion dates or current step has changed; and initiating communication of a notification to the customer, the notification indicating that the at least one step, completion date or current step has changed.

In some embodiments, the method also includes determining that an activity associated with one of the customer's accounts or requests will occur within a predetermined period of time; and initiating communication of a notification to the customer, the notification indicating that the activity will occur within the predetermined period of time.

In some embodiments, the method includes determining that a pending request requires customer attention; initiating communication of a notification to the customer, the notification indicating that the pending request requires customer attention; and receiving customer input regarding the pending request.

According to embodiments of the invention, a computer program product includes a non-transitory computer-readable medium comprising a set of codes for causing a computer to determine that the customer has been authenticated to a financial institution online banking session; in response to determining the customer has been authenticated, initiate presentation of a customer interface comprising a listing of all of the customer's accounts, an activity list, and a listing of all of the customer's requests. The set of codes further causes the computer to determine a status of at least one customer request; and present, as part of the customer interface, the status of the at least one customer request.

In some embodiments, determining the status of the at least one customer request comprises accessing a request status table comprising a plurality of request status entries, the table automatically updated when any request status changes.

### BRIEF DESCRIPTION OF THE DRAWINGS

Having thus described embodiments of the invention in general terms, reference will now be made to the accompanying drawings, where:

FIG. 1 is a high level flowchart illustrating a general process flow for providing an online banking customer interface with comprehensive access to all of the customer's accounts, an activity list and/or any outstanding customer requests, in accordance with embodiments of the invention;

FIG. 2 is block diagram of an environment wherein embodiments of the invention operate, in accordance with embodiments of the invention;

FIG. 3 is a flowchart illustrating a general process flow for updating request status according to embodiments of the invention, in accordance with embodiments of the invention;

FIG. 4 is a flowchart illustrating a general process flow for presentation of a resolution process associated with a customer request, in accordance with embodiments of the invention;

FIG. 5 is a flowchart illustrating a process flow for notifying a customer of a future activity, in accordance with embodiments of the invention;

FIG. 6 is a flowchart illustrating a process flow for receiving customer input regarding a pending request, in accordance with embodiments of the invention; and

FIG. 7 is a screenshot of a comprehensive interface and request tracker tool, in accordance with embodiments of the invention.

### DETAILED DESCRIPTION OF EMBODIMENTS OF THE INVENTION

Embodiments of the invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Embodiments of the invention provide an online platform for financial institution customers that enables a comprehensive view into the customer's banking activity. Customers can quickly view recent transactions, view scheduled activities and track the status of any request at any time. Some benefits of these innovations are that phone calls, chats, emails and other messages to/with customer service are reduced and therefore, agents of the financial institution may focus their efforts on other customer services issues.

Although financial institution customers are typically able to initiate requests (such as customer service requests, disputes such as disputed charges, physical orders such as ordered checks, new card issuance, new account status or the like) through online banking and/or a mobile banking application, customers do not have access to tracking information associated with the requests unless they speak with a customer service representative or agent. Even when customers do speak with a customer service representative, the representative may not have up-to-date information regarding the status of the customer's request. Based on research performed with financial institution customers, the customers want to know the status of activities and to be given accurate time estimates for completion of those activities, features that have not been afforded financial institution customers in the past.

Embodiments of the invention disclosed herein provide features that address the above research findings by providing a request tracker tool. Various embodiments of the request tracker tool include different sections. One section is a summary that provides the customer with an easy to read high-level overview of information about a request. Another section is a status section, which shows all the steps involved in resolution of a request and estimated completion dates for each step. A third section provides a communication history, which offers a record of all service interactions related to the request. A fourth and final section provides documents, which contains copies of any files uploaded by the customer and/or agents of the financial institution in relation to the request.

In various embodiments, the request tracker tool allows customers to view an interactive activity list. The activity list may enable the customer to chat, conduct a video conference with an agent or otherwise conduct business with the financial institution.

The request tracker tool dynamically updates its own content and pushes changes to a completed activity feed, which is a communication feed that the customer may subscribe to. The tool may also provide upcoming notifications and alerts regarding upcoming activities associated with the customer's bank accounts, upcoming steps being performed in relation to a request and other information regarding ongoing activities.

A customer may access the request tracker tool using one or more computing devices. These various devices are referred to herein as a user device or customer device. The user device may be a desktop computer, a laptop computer, a tablet, a mobile device, or another type of computing device. For example, the user device may be a gaming system, a kiosk at a merchant or a public locale, or a rental device. In an exemplary embodiment, the user device is a computing device such as a tablet that allows the user to conduct a video conference, e.g., the user device includes a video camera, a microphone, speakers, and a display screen. In an embodiment, the user device is the previously discussed customer device.

Embodiments of the invention are directed to systems, methods and computer program products for providing an online banking customer interface with comprehensive access to all of the customer's accounts, an activity list and any outstanding customer requests. Embodiments determine that the customer has been authenticated to a financial institution online banking session; in response to determining the customer has been authenticated, initiate presentation of a customer interface comprising a listing of all of the customer's accounts, an activity list, and a listing of all of the customer's requests; determine a status of at least one customer request; and present the status of the at least one customer request. Some embodiments present a resolution process associated with at least one customer request that includes a plurality of steps to be completed, a plurality of expected completion dates each associated with the steps, and a current step.

As such, embodiments of the present invention improve the ability of an entity such as a financial institution, to provide real-time, or near real-time updates regarding a customer's activities and requests, as well as processes being implemented to address the customer's requests, in a comprehensive interactive interface. The real-time information used to provide the interface is based not only on customer and/or associate/agent input, but also based on dynamic contextual information that changes when the customer and/or an associate/agent takes actions within the comprehensive interface, with regard to one or more resolution processes and/or one or more resolution process steps. The aggregation of information/data from multiple disparate sources in order to generate and present the comprehensive interface requires complex interconnectivity among all the systems involved and near real-time data communication and processing. Thus, the system of the present invention provides significant improvements over traditional interface methods because it actively and dynamically updates the customer's information, requests and resolution processes. The present invention reduces the amount of time it takes for a customer to identify the relevant content in which the user may be interested and provides the customer an opportunity to manage multiple pieces of information using one interface that aggregates and consolidates various types of information seemlessly.

As used herein, a user may be a customer of the financial institution but is not required to be. For example, the user may be an existing customer of the financial institution, meaning that the user has had at least one account with the financial institution either currently or previously active. The user may also be a new customer or a prospective customer of the financial institution. For example, the user may be an individual searching for competitive mortgage rates and discussing mortgage applications with multiple financial institutions. The user may not have a current or previous relationship with the financial institution but is considering developing one and would like to ask questions of a representative regarding the possibility of becoming a customer.

The system may establish an operative connection between the user device and a system associated with the representative of the financial institution. The system associated with the representative is to be broadly construed as being a set of hardware and software that provides the representative access to the conference. The system may include at least a portion of the financial institution system, e.g., the server and databases associated with the financial institution. For example, the system associated with the agent may provide access to a user's financial transaction history for a plurality of accounts. In some embodiments, the user first provides an access code or authentication code allowing the user and the representative to access portions of the user's data on the financial institution server. The system associated with the representative may also include the specific hardware and software that allows the representative to participate in the conference. This hardware and software may include the video camera, speaker, microphone, headset, display, and/or operating system for connecting with a variety of user computing devices.

In an embodiment, the agent is an employee of the financial institution. The agent may be a general customer service representative/agent or a specialized representative/agent.

For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a user to establish an account with the entity. An “account” may be the relationship that the user has with the entity. Examples of accounts include a deposit account, such as a transactional account (e.g., a banking account), a savings account, an investment account, a money market account, a time deposit, a demand deposit, a pre-paid account, a debit account, a credit account, a non-monetary user profile that includes only personal information associated with the user, or the like. The account is associated with and/or maintained by the entity. In other embodiments, an entity may not be a financial institution. The operative connection established between the user device and the system associated with the financial institution facilitates the request tracker tool of the embodiments discussed herein.

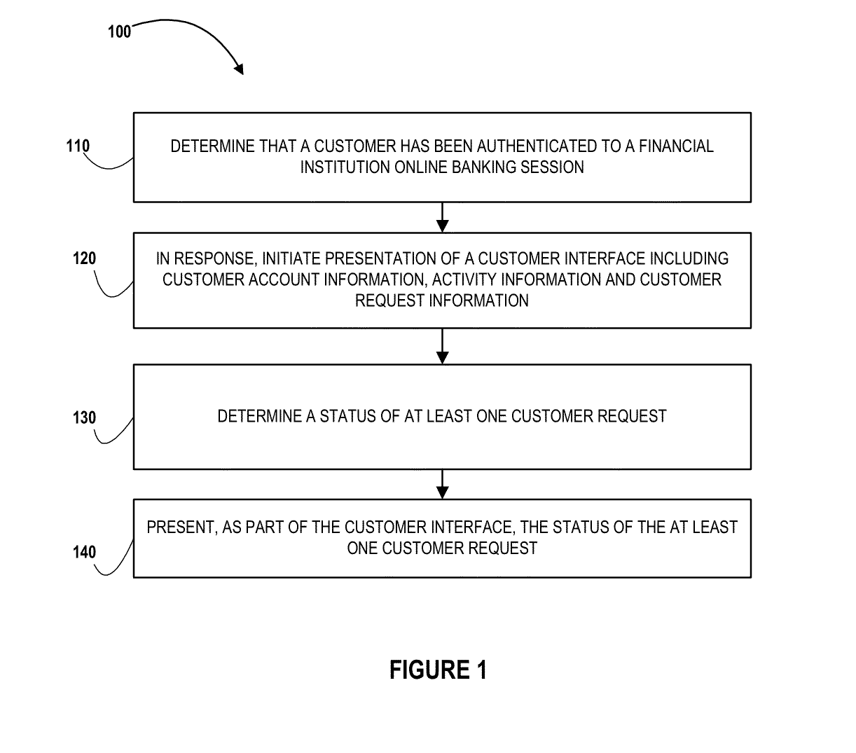

Referring now to FIG. 1, a flowchart illustrating a method 100 for providing an online banking customer interface with comprehensive access to all of the customer's accounts, an activity list and/or any outstanding customer requests. The first step, represented by Block 110, is to determine that a customer has been authenticated to a financial institution online banking session. The customer may be authenticated into an online banking session using a user device navigating to the financial institution's website over the Internet or may be authenticated using a mobile device banking application.

The next step, represented by Block 120, is to initiate presentation, in response to determining the customer has been authenticated, of a customer interface including customer account information, activity information and customer request information. In some cases, the customer has expressed an interest in using the comprehensive view into the customer's accounts, activities and request status. Thus, in some cases, the customer opts-in to use of the comprehensive view, and if the customer chooses not to opt-in, the customer is presented with a standard online banking interface. Further, in some cases, the customer may customize the comprehensive view to include none, some or all of the customer's accounts associated with the financial institution providing the comprehensive interface. In some cases, the customer can provide access to accounts maintained by other financial institutions by providing authentication information to the comprehensive interface so that the interface may retrieve balance, transaction and/or other information from other financial institutions. In some embodiments, the customer may indicate that the customer wants none, some or all activities involving the customer's interactions with the financial institution and/or activities being conducted by the financial institution on the customer's behalf. In yet other embodiments, the customer may specify that the customer desires none, some or all of the customer's pending (or current) requests involving the financial institution to be presented by the comprehensive interface. The customer may also specify the level of granularity with which information is provided with regard to each pending request. For example, the customer may specify a desire to have access to information regarding the various pending requests and their respective expected completion dates, but may specify that the customer does not desire information regarding the resolution process(es) associated with pending requests or their respective expected completion dates.

The next step, represented by Block 130, is to determine a status of at least one customer request. Determining the status of a pending request may be done in a variety of ways. One way is for the request tracker tool to automatically, or in response to verifying that the customer has been authenticated to the online banking session or mobile application, to request status updates from one or more request information repositories. These repositories may be maintained by the financial institution to store information regarding the various requests submitted by customers of the financial institution. Also, the repositories may push communications to web servers or application servers that present the request tracker tool to customers that indicate the current or most recent status of various pending requests. In this regard, there may be a central hub for collecting information regarding a customer or a customer's accounts, activities, and/or requests so that the financial institution systems may quickly request information from the central hub and be confident of its up-to-date and accurate status.

The next step, represented by Block 140, is to present, as part of the customer interface, the status of the at least one customer request. The status of customer requests may be presented in a variety of formats. For example, each customer request may be presented in a listing that includes information regarding the status of the request, the current step of the request resolution process, the expected completion date, one or more contacts/agents associated with resolution of the request and/or the like.

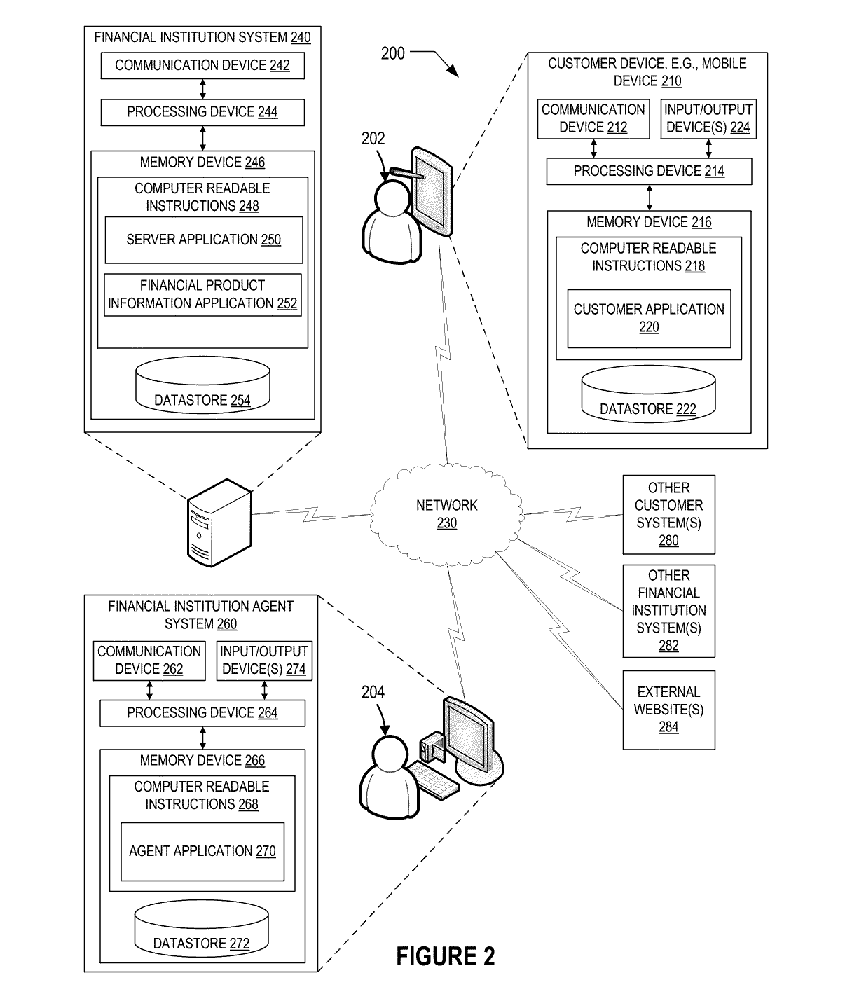

Referring now to FIG. 2, a block diagram illustrates an environment 200 wherein a customer 202 uses an online banking application associated with a financial institution agent 204 using a customer device 210 and a financial institution agent system 260, respectively. The environment also may include a financial institution system 240, other customer systems 280, other financial institution systems 282 and/or external websites 284. The systems and devices communicate with one another over a network 230 and perform one or more of the various steps and/or methods according to embodiments of the invention discussed herein.

A customer device 210 may be configured for use by a customer or other user, for example, to access one or more other financial institution applications such as the customer conference application 220. The customer device 210 may be or include a computer system, server, multiple computer system, multiple servers, or some other computing device configured for use by a user, such as a desktop, laptop, tablet, or a mobile communications device, such as a smartphone. The mobile device 210 has a communication device 212 communicatively coupled with a processing device 214, which is also communicatively coupled with a memory device 216 and one or more input and/or output devices 224, for example, an image capture device such as camera and/or a microphone. The processing device 214 is configured to control the communication device 212 such that the customer device 210 communicates across the network 230 with one or more other systems, for example, the financial institution representative system 260. The processing device 214 is also configured to access the memory device 216 in order to read the computer readable instructions 218, which in some embodiments include a customer conference application 220. The memory device 216 also may have a datastore 222 or database for storing pieces of data for access by the processing device 214.

The financial institution agent system 260 may be a workstation used by an agent to communicate with customers using the conference application. In some embodiments, the financial institution agent system 260 may communicate with one or more of the other systems or devices and may perform one or more steps and/or one or more methods as described herein. In some embodiments, the financial institution agent system 260 includes a communication device 262 communicatively coupled with a processing device 264, which is also communicatively coupled with a memory device 266 one or more input and/or output devices 224, for example, an image capture device such as camera and/or a microphone. The processing device 264 controls the communication device 262 such that the financial institution agent system 260 communicates across the network 230 with one or more other systems or devices. The processing device 264 is also configured to access the memory device 266 in order to read the computer readable instructions 268, which in some embodiments include an agent application 270 having instructions for communicating with the customer application 220 running on the customer device 210 and/or the server application 250 running on the financial institution system 240. In some embodiments, the financial institution agent system 260 includes one or more datastores 272 for storing and providing one or more pieces of data used by the agent during conferences with customers.

A financial institution system 240 is a computer system, server, multiple computer systems and/or servers or the like. The financial institution system 240, in the embodiments shown has a communication device 242 communicably coupled with a processing device 244, which is also communicably coupled with a memory device 246. The processing device 244 is configured to control the communication device 242 such that the financial institution system 240 communicates across the network 230 with one or more other systems. The processing device 244 is also configured to access the memory device 246 in order to read the computer readable instructions 248, which in some embodiments includes a server application 250. The memory device 246 also has a datastore 254 or database for storing pieces of data for access by the processing device 244. In some embodiments, the agent application interacts with the server application to access information, documents or other data for use during an online banking session, online banking application session and/or conference call. In some embodiments, a financial product information application 252 retrieves information regarding financial products being discussed during an online banking session, application session or call between a customer and an agent and provides the information to the customer and/or the agent during the session/call and/or after the session/call has ended.

The applications 220, 250 and 270 are for instructing the processing devices 214, 244 and 264 to perform various steps of the methods discussed herein, and/or other steps and/or similar steps. In various embodiments, one or more of the applications 220, 250 and 270 are included in the computer readable instructions stored in a memory device of one or more systems other than the systems 240 and 260 or device 210. For example, in some embodiments, the application 220 is stored and configured for being accessed by a processing device of one or more other customer systems 280 connected with an online banking session/application or call through network 230. In various embodiments, the applications 220, 250 and 270 stored and executed by different systems/devices are different. In some embodiments, the applications 220, 250 and 270 stored and executed by different systems may be similar and may be configured to communicate with one another, and in some embodiments, the applications 220, 250 and 270 may be considered to be working together as a singular application despite being stored and executed on different systems. In some embodiments, the applications 220, 250 and 270 stored and executed by the customer device and/or an application stored and executed on one of the other systems is a stand-alone application 220 and does not necessarily communicate or rely on any other applications for data, processing or otherwise, except for providing a connection with a representative through the application 270.

In various embodiments, one of the systems discussed above, such as the financial institution system 240, is more than one system and the various components of the system are not collocated, and in various embodiments, there are multiple components performing the functions indicated herein as a single device. For example, in one embodiment, multiple processing devices perform the functions of the processing device 244 of the financial institution system 240 described herein. In various embodiments, the financial institution system 240 includes one or more of the financial institution representative system 260, the other financial institution systems 282, and/or any other system or component used in conjunction with or to perform any of the method steps discussed herein.

In various embodiments, the financial institution system 240, the customer device 210, the financial institution representative system 260 and/or other systems may perform all or part of a one or more method steps discussed above and/or other method steps in association with the method steps discussed above. Furthermore, some or all the systems/devices discussed here, in association with other systems or without association with other systems, in association with steps being performed manually or without steps being performed manually, may perform one or more of the steps of method 100, the other methods discussed below, or other methods, processes or steps discussed herein or not discussed herein.

According to embodiments of the invention, an online banking system, which may include one or more of the financial institution system 240, the customer device 210 and/or the financial institution agent system 260, may provide an online banking session/application interaction with a customer. When “system” is used in general, that is, without referring to a specific system, it should be understood that one or more of the systems and device discussed with reference to FIG. 2 may be performing the method step or function being discussed. The system may provide the customer an opportunity to interact with an interface providing comprehensive information regarding the customer's bank accounts, available activities, and request statuses.

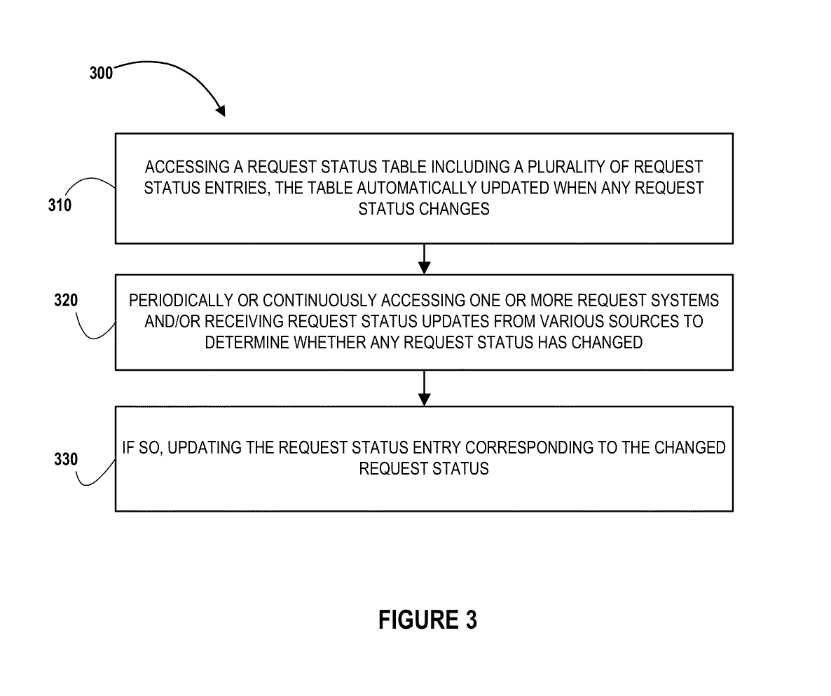

Referring now to FIG. 3, a flowchart illustrates a method 300 for updating request status according to embodiments of the invention. The first step, represented by Block 310, is accessing a request status table including a plurality of request status entries. The table, in some embodiments, automatically updates when any request status changes. In some embodiments, as represented by Block 320, the next step is to access one or more request systems to obtain request status updates. In other embodiments, as represented by Block 330, the next step is to receive status updates from various sources to determine whether any request status has changed. In various embodiments, steps 320 are performed periodically or continuously. In cases when any request status has changed, the next step is updating the request status entry in the table corresponding to the changed request status, as represented by Block 330.

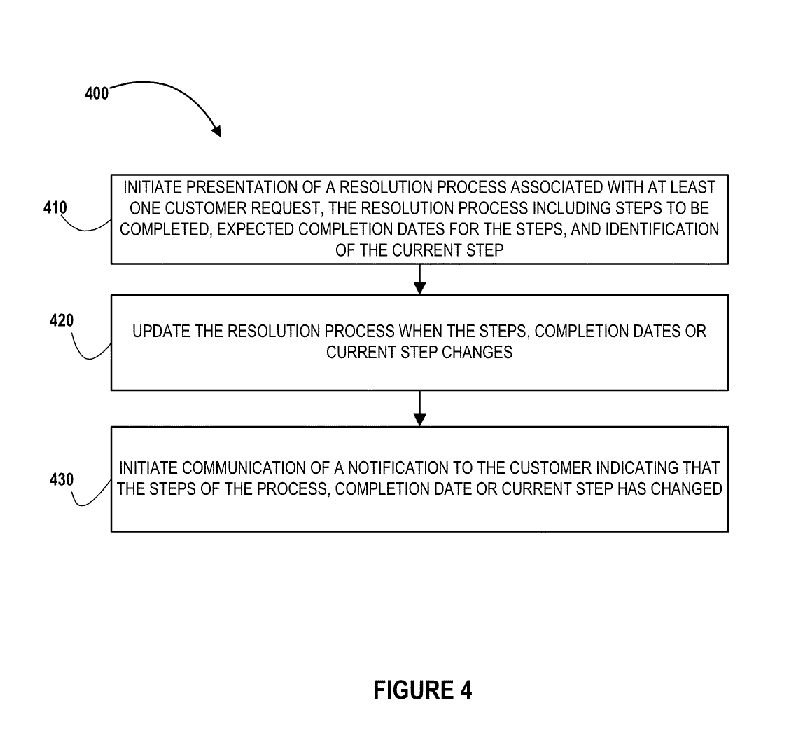

Referring now to FIG. 4, a flowchart illustrates a method 400 for presentation of a resolution process associated with a customer request. The first step, represented by Block 410, is to initiate presentation of a resolution process associated with at least one customer request. The resolution process includes steps to be completed, expected completion dates for the steps and identification of the current step. The next step, represented by Block 420, is to update the resolution process when the steps, completion dates or current step changes. These updates may be made by one or more agents associated with the request and/or the resolution process and/or associated with one or more of the individual steps in the resolution process. The next step, represented by Block 430, is to initiate communication of a notification to the customer indicating that the steps of the process, completion date or current step has changed.

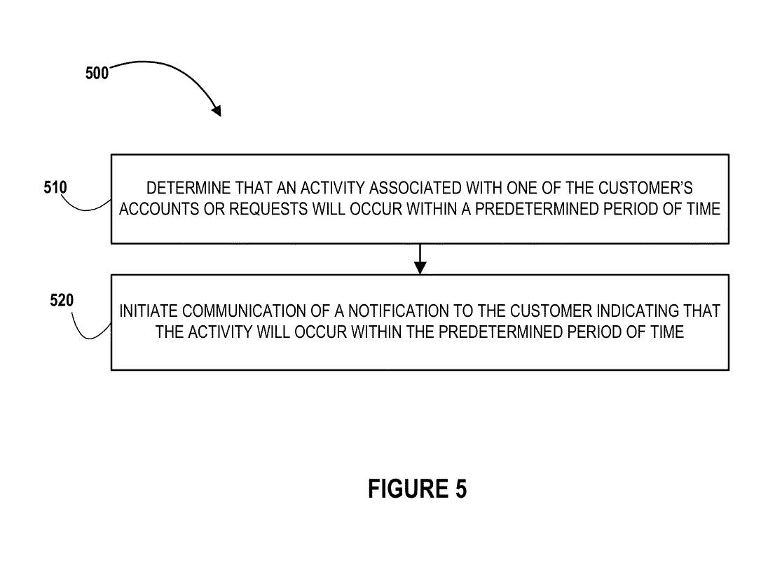

Referring now to FIG. 5, a flowchart illustrates a method 500 for notifying a customer of a future activity. The first step, represented by Block 510, is to determine that an activity associated with one of the customer's accounts or requests will occur within a predetermined period of time. The next step, represented by Block 520, is to initiate communication of a notification to the customer indicating that the activity will occur within the predetermined period of time.

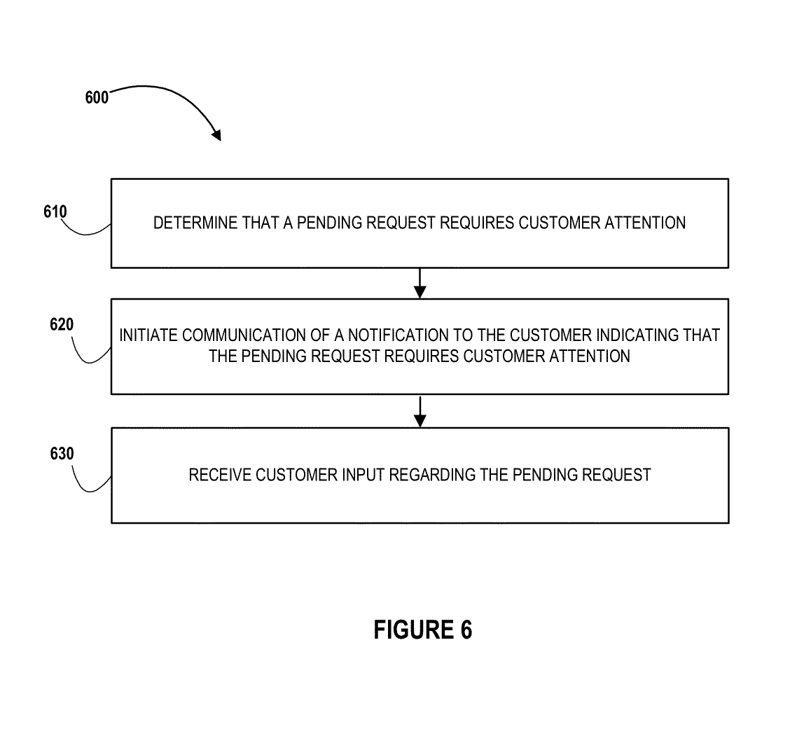

Referring now to FIG. 6, a flowchart illustrates a method 600 for receiving customer input regarding a pending request. The first step, as represented by Block 610, is to determine that a pending request requires customer attention. For example, the financial institution may need customer information such as the customer's preferences with regard to handling specific circumstances. The next step, represented by Block 620, is to initiate communication of a notification to the customer indicating that the pending request requires customer attention. The next step, as represented by Block 630, is to receive customer input regarding the pending request.

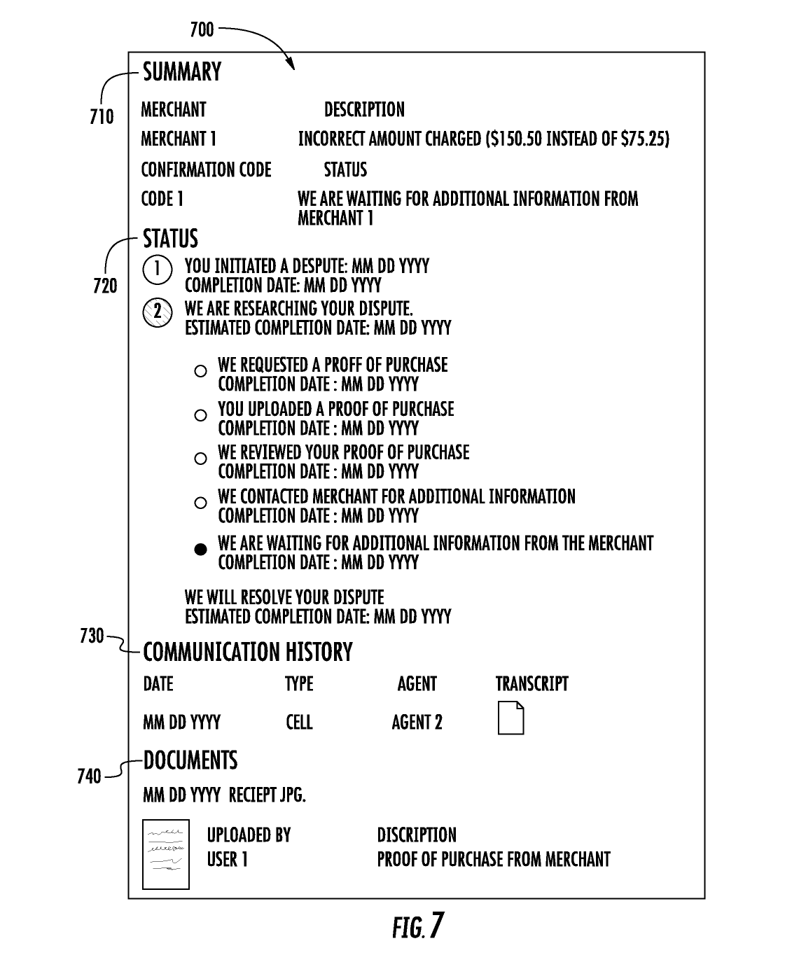

Referring now to FIG. 7, a screenshot 700 of an embodiment of the comprehensive interface and request tracker tool is shown. As discussed above, various embodiments of the request tracker tool include different sections. One section is a summary section 710 that provides the customer with an easy to read high-level overview of information about a request. Another section is a status section 720, which shows all the steps involved in resolution of a request and estimated completion dates for each step. The status section may also include visualization of past progress and an indication of the current step, as well as the completion date for the overall resolution process. A communication section 730 offers a record of all service interactions related to the request and allows a customer to quickly contact an agent associated with a request or a step of a resolution process associated with a request. The communication section 730 may also include access to a text transcript or audio recording of customer service interactions. A documents section 740 contains copies of any files uploaded by the customer and/or agents of the financial institution in relation to the request.

In various embodiments, the system may aggregate information from any or all mediums or sources available to the system in order to determine up-to-date information regarding one or more requests. In various embodiments, the system may determine that one or more requests has been updated or other information related to or relevant to the customer has changed, and the system may notify the customer of the change and invite the customer to log on and view information and/or make any necessary updates or changes to the customer's preferences, accounts or the like.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, etc.), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. An apparatus for providing an online banking customer interface with comprehensive access to all of the customer's accounts, an activity list and any outstanding customer requests, the apparatus comprising:
a memory;
a processor; and
a computing module stored in the memory, executable by the processor, and to cause the processor to:
determine that the customer has been authenticated to a financial institution online banking session;
in response to determining the customer has been authenticated, initiate presentation of a customer interface comprising:
a listing of all of the customer's accounts,
an activity list, and
a listing of all of the customer's requests;
determine a status of at least one customer request; and
present, as part of the customer interface, the status of the at least one customer request.

2. The apparatus of claim 1, wherein determining the status of the at least one customer request comprises accessing a request status table comprising a plurality of request status entries, the table automatically updated when any request status changes.

3. The apparatus of claim 2, wherein the computing module further causes the processor to:
periodically or continuously access one or more request systems to determine whether any request status has changed; and
if so, update the request status entry corresponding to the changed request status.

4. The apparatus of claim 1, wherein the computing module further causes the processor to:
receive, from a plurality of sources, request status updates; and
in response to receiving request status updates, updating any request status entries corresponding to the received request status updates.

5. The apparatus of claim 1, wherein the computing module further causes the processor to:
initiate presentation of a resolution process associated with at least one customer request, the resolution process comprising a plurality of steps to be completed, a plurality of expected completion dates each associated with one of the plurality of steps, and a current step of the process.

6. The apparatus of claim 5, wherein the computing module further causes the processor to:
update the resolution process when the steps, completion dates or current step changes.

7. The apparatus of claim 5, wherein the computing module further causes the processor to:
determine that at least one of the steps, completion dates or current step has changed; and
initiate communication of a notification to the customer, the notification indicating that the at least one step, completion date or current step has changed.

8. The apparatus of claim 1, wherein the computing module further causes the processor to:
determine that an activity associated with one of the customer's accounts or requests will occur within a predetermined period of time; and
initiate communication of a notification to the customer, the notification indicating that the activity will occur within the predetermined period of time.

9. The apparatus of claim 1, wherein the computing module further causes the processor to:
determine that a pending request requires customer attention;
initiate communication of a notification to the customer, the notification indicating that the pending request requires customer attention; and
receive customer input regarding the pending request.

10. A method for providing an online banking customer interface with comprehensive access to all of the customer's accounts, an activity list and any outstanding customer requests, the method comprising:
determining that the customer has been authenticated to a financial institution online banking session;
in response to determining the customer has been authenticated, initiating presentation of a customer interface comprising:
a listing of all of the customer's accounts,
an activity list, and
a listing of all of the customer's requests;
determining a status of at least one customer request; and
presenting, as part of the customer interface, the status of the at least one customer request.

11. The method of claim 10, wherein determining the status of the at least one customer request comprises accessing a request status table comprising a plurality of request status entries, the table automatically updated when any request status changes.

12. The method of claim 11, further comprising:
periodically or continuously accessing one or more request systems to determine whether any request status has changed; and
if so, update the request status entry corresponding to the changed request status.

13. The method of claim 10, further comprising:
receiving, from a plurality of sources, request status updates; and
in response to receiving request status updates, updating any request status entries corresponding to the received request status updates.

14. The method of claim 10, further comprising:
initiating presentation of a resolution process associated with at least one customer request, the resolution process comprising a plurality of steps to be completed, a plurality of expected completion dates each associated with one of the plurality of steps, and a current step of the process.

15. The method of claim 14, further comprising:
updating the resolution process when the steps, completion dates or current step changes.

16. The method of claim 14, further comprising:
determining that at least one of the steps, completion dates or current step has changed; and
initiating communication of a notification to the customer, the notification indicating that the at least one step, completion date or current step has changed.

17. The method of claim 10, further comprising:
determining that an activity associated with one of the customer's accounts or requests will occur within a predetermined period of time; and
initiating communication of a notification to the customer, the notification indicating that the activity will occur within the predetermined period of time.

18. The method of claim 10, further comprising:
determining that a pending request requires customer attention;
initiating communication of a notification to the customer, the notification indicating that the pending request requires customer attention; and
receiving customer input regarding the pending request.

19. A computer program product for providing an online banking customer interface with comprehensive access to all of the customer's accounts, an activity list and any outstanding customer requests, the computer program product comprising:
a non-transitory computer-readable medium comprising a set of codes for causing a computer to:
determine that the customer has been authenticated to a financial institution online banking session;
in response to determining the customer has been authenticated, initiate presentation of a customer interface comprising:
a listing of all of the customer's accounts,
an activity list, and
a listing of all of the customer's requests;
determine a status of at least one customer request; and
present, as part of the customer interface, the status of the at least one customer request.

20. The computer program product of claim 19, wherein determining the status of the at least one customer request comprises accessing a request status table comprising a plurality of request status entries, the table automatically updated when any request status changes.
